(19) United States
(12) Patent Application Publication
(10) Pub. No.: US 2026/0080645 A1
(43) Pub. Date: Mar. 19, 2026

(54) Systems, Methods, and User Interfaces for Determining Autonomous Mobile Robot Payload Sizing

(71) Applicant: OMRON Corporation, Kyoto-shi (JP)

(72) Inventors: Seth Dunten, Castro Valley, CA (US); Aastav Sasha Sen, Fremont, CA (US); Shen Wang, Pleasanton, CA (US)

(73) Assignee: OMRON Corporation, Kyoto-shi (JP)

(21) Appl. No.: 18/889,334

(22) Filed: Sep. 18, 2024

(51) Int. Cl. G06T 19/20

(52) U.S. Cl. CPC G06T 19/20; G06T 2200/24; G06T 2219/2016

(57) ABSTRACT

The various implementations described herein include methods and systems for determining Autonomous Mobile Robot (AMR) payload sizing. In one aspect, a method for visualizing payload center of gravity envelopes includes displaying a user interface. The method includes receiving, via the user interface, an AMR type and a corresponding set of operating parameters. The method includes detecting a user input at a location on the user interface corresponding to a control element on the user interface. The method includes, in response to detecting the user input, generating a center of gravity (CG) envelope based on the AMR type and the set of operating parameters. The method also includes, after generating the CG envelope, displaying a visualization of the CG envelope.

### TECHNICAL FIELD

The disclosed embodiments relate generally to robot technology, and more specifically to systems, methods, and user interfaces that manage payload sizing of autonomous mobile robots (AMRs) and facilitate design and verification of payloads and/or toppers for AMRs.

### BACKGROUND

AMRs can be used to transport payloads for industrial applications, and are particularly useful for companies seeking to harness a flexible manufacturing paradigm. However, improper payload capacity or positioning on an AMR can result in the AMR operating outside its intended use conditions, reduced performance or efficiency of the AMR, as well as damage to the AMR or the payload. Moreover, the payload limits or volumes that represent appropriate positions of the payload center of mass can also vary depending on actual environmental conditions.

### SUMMARY

In accordance with at least some embodiments disclosed herein is the realization that a tool is needed to allow a user to design payload limits and/or volumes that represent appropriate positions of the payload center of mass for AMRs based on actual operating conditions. It is noted that some users rely on 2D static plots that are found in user manuals to determine appropriate payload masses and/or dimensions for use with an AMR. These plots are usually 2D envelope plots that depict limited speed (e.g., one or two options), payload mass (e.g., three to six options), and/or incline conditions (e.g., binary, either yes or no). In accordance with at least some embodiments disclosed herein is the realization that it can be challenging for a user to interpret and/or interpolate the 2D plots. For example, the plots may only indicate a small set of discrete speed, mass, and incline options, and a user working with a different configuration of speed, mass, or incline will have to exercise judgment to decide whether it is appropriate to operate the autonomous mobile robot (AMR) with the user's configuration. As another example, a user is required to comply with payload masses and/or dimensions that are within a center of mass (or center of gravity) envelope. It may be appropriate for the AMR to carry a payload whose center of gravity falls outside the envelope when the operating environment is relatively flat (e.g., with no slopes or inclines). In accordance with at least some embodiments disclosed herein is the realization that the challenges associated with interpreting and/or interpolating the 2D envelope plots can lead to increased potential for human error and may require advice and guidance from an expert.

The present disclosure describes, amongst other things, an interactive AMR sizing tool that enables a user to design payload parameters (such as rotational inertia limits and volumes) that represent appropriate positions of the payload center of mass (also referred to as center of gravity (CG) envelopes or CG envelopes). The disclosed interactive AMR sizing tool can estimate an AMR service life based on the parameters entered and compiled test data. In accordance with some embodiments disclosed herein, the AMR sizing tool includes a number of user-adjustable operating parameters that allow a user to design one or more of: payloads, maximum and minimum driving capabilities, environmental conditions, scope of standards, and general use cases for a variety of mobile robots. In this way, the tool allows for the qualification that a certain payload is appropriate for use with the AMR without the need for additional validation, even in special use cases.

In some embodiments, the AMR sizing tool generates and displays a CG envelope plot in a three-dimensional (3D) perspective. A user can interact with the CG envelope plot to determine whether a proposed payload and payload position falls within a CG envelope corresponding to the CG envelope plot. Accordingly, a user no longer has to interpolate the plot, or exercise their personal judgment, to decide whether it is appropriate to operate the AMR with the proposed payload and volume configuration.

As disclosed, the interactive AMR sizing tool provides a user-friendly approach that allows for a precise design for both general and special (e.g., tailored conditions and/or limits) use cases for a variety of AMRs, without the need for any advice or guidance from an expert (e.g., excluding cases in which the intended use case lies outside the AMR's capabilities). The AMR sizing tool also serves as a means to communicate what should not be altered, what can be altered, and any related consequence(s). In some embodiments, the AMR sizing tool serves the additional purposes of educating users of the capabilities of each of the AMRs.

Some embodiments of the present disclosure are directed to an interactive system and user interface that allow for the design of applications of an individual robot through modification of the conditions or limitations pertaining to the dynamic or static models of the robot.

The systems, methods, and user interfaces of this disclosure each have several innovative aspects, no single one of which is solely responsible for the desirable attributes disclosed herein.

In accordance with some embodiments, a method of visualizing payload center of gravity envelopes is performed by a computing system having one or more processors and memory that is in communication with the one or more processors. The method includes displaying a user interface and receiving, via the user interface, an autonomous mobile robot (AMR) type and a corresponding set of operating parameters. The method includes detecting a user input at a location on the user interface corresponding to a control element on the user interface. The method includes, in response to detecting the user input, generating a center of gravity (CG) envelope based on the AMR type and the set of operating parameters. The method includes, after generating the CG envelope, displaying a visualization of the CG envelope.

In accordance with some embodiments, a method of verifying a payload is performed at a computing system that includes one or more processors and memory that is in communication with the one or more processors. The method includes receiving a first user input selecting a center of gravity (CG) envelope for a first autonomous mobile robot (AMR) type. The method includes, in response to detecting the first user input, displaying a visualization of the CG envelope. The method includes while displaying the visualization of the CG envelope, receiving a second user input adjusting an operating parameter for the AMR type. The adjustment of the operating parameter comprises selection of a value from a set of preset values for the operating parameter. The method includes in response to detecting the second user input, updating the visualization of the CG envelope in accordance with the adjustment to the operating parameter.

In accordance with some embodiments, a computing system includes one or more processors and memory coupled to the one or more processors. The memory stores one or more programs configured for execution by the one or more processors. The one or more programs include instructions for performing any of the methods disclosed herein.

In accordance with some embodiments, a non-transitory computer readable storage medium stores one or more programs configured for execution by a computing system having a one or more processors, and memory. The one or more programs include instructions for performing any of the methods disclosed herein.

In various embodiments of this application, methods, systems, and user interfaces are disclosed that support the determination of AMR payload sizing.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

For a better understanding of the aforementioned systems, methods, and graphical user interfaces, as well as additional systems, methods, and graphical user interfaces that provide data visualization analytics, reference should be made to the Detailed Description of Implementations below, in conjunction with the following drawings in which like reference numerals refer to corresponding parts throughout the figures.

FIGS. 1A and 1B illustrate example graphical user interfaces of an AMR sizing tool, in accordance with some embodiments.

FIGS. 2A-2C illustrate example graphical user interfaces of an AMR sizing tool, in accordance with some embodiments.

FIGS. 3A-3D illustrate example use cases, in accordance with some embodiments.

FIG. 4 is a block diagram of an example computing device, in accordance with some embodiments.

FIGS. 5A-5C provide a flowchart of an example process for visualizing payload center of gravity envelopes, in accordance with some embodiments.

FIG. 6 is a flowchart of an example process verifying a payload, in accordance with some embodiments.

Reference will now be made to embodiments, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DETAILED DESCRIPTION OF IMPLEMENTATIONS

Some embodiments of the present disclosure are directed to systems, methods, and user interfaces for determining AMR payload sizing. In accordance with some embodiments, the disclosed AMR sizing tool aids design of payloads and toppers and associated qualification that a certain payload is appropriate under certain given conditions such as (i) a robot (e.g., AMR) configuration and/or performance, (ii) whether operation of the robot requires compliance with standards, and/or (iii) physical or environmental conditions of the robot. For example, in some embodiments, robot configuration and/or performance can include operating parameters of the robot, such as a maximum translational deceleration, a maximum centripetal acceleration, a maximum forward translational acceleration, and a maximum reverse translational acceleration. In some embodiments, the robot is configured to operate in compliance with a standard such as the UL 3100 standard, e.g., be statically stable on a 10-degree ramp. Physical or environmental conditions of the robot can include one or more of: a payload mass of the robot, whether the robot is configured to operate on ramps, and a value of a corresponding ramp angle.

In some embodiments, using the above conditions (e.g., limits), the disclosed AMR sizing tool computes a volume of the payload that can be placed on the robot (e.g., with respect to the payload center of gravity, measured relative to a robot center on a ground plane). In some instances, the volume has a pyramid shape. The volume can be displayed by the tool via a graphical user interface (GUI). Through the GUI, a user can modify the one or more of the above conditions (e.g., limits), which in turn causes the tool to generate updated CG envelopes with modified size(s) and/or placement(s) of the payload volume.

In some embodiments, an exemplary application of the AMR sizing tool includes receiving specification of a robot type and related conditions/limits (e.g., via a generator tab of the GUI). The tool generates a CG envelope in accordance with the specification. In some embodiments, the CG envelope is stored as a file. In some embodiments, the tool displays, in the GUI (e.g., via a Plots tab), visualizations (e.g., as 2D and 3D plots) of the payload CG envelope that has been generated. In some embodiments, the GUI displays (e.g., via the Plots tab) a visualization of the payload moment of inertia limit values (e.g., as a 2D plot). In some embodiments, the tool can generate updated CG envelope(s) in accordance with receiving modified values of the operating parameters. For example, a user can adjust the values of the operating parameters and cause the tool to generate additional CG envelopes until a desired use case is satisfied. In some embodiments, if a use case cannot be reasonably satisfied through the use of the tool, then the use case is deemed to be outside of the capabilities of the AMR robot.

In some embodiments, the disclosed AMR sizing tool includes a default, pre-generated file that includes results that are pre-generated based on preset values. In some embodiments, the results from the pre-generated file can be quickly retrieved and used instead of, or in addition to, a CG envelope, which is generated according to a user-specified set of conditions or limits (and which can take a longer time to generate). In some embodiments, the 2D plots can be exported.

In some embodiments, upon completion of the design of a use case, a user can implement these conditions or limits in the robot configuration and within their operating environment (e.g., avoiding ramps). The disclosed AMR sizing tool allows for the qualification that the designed use case is appropriate as long as it is compliant to the boundaries illustrated by the tool's output CG envelopes.

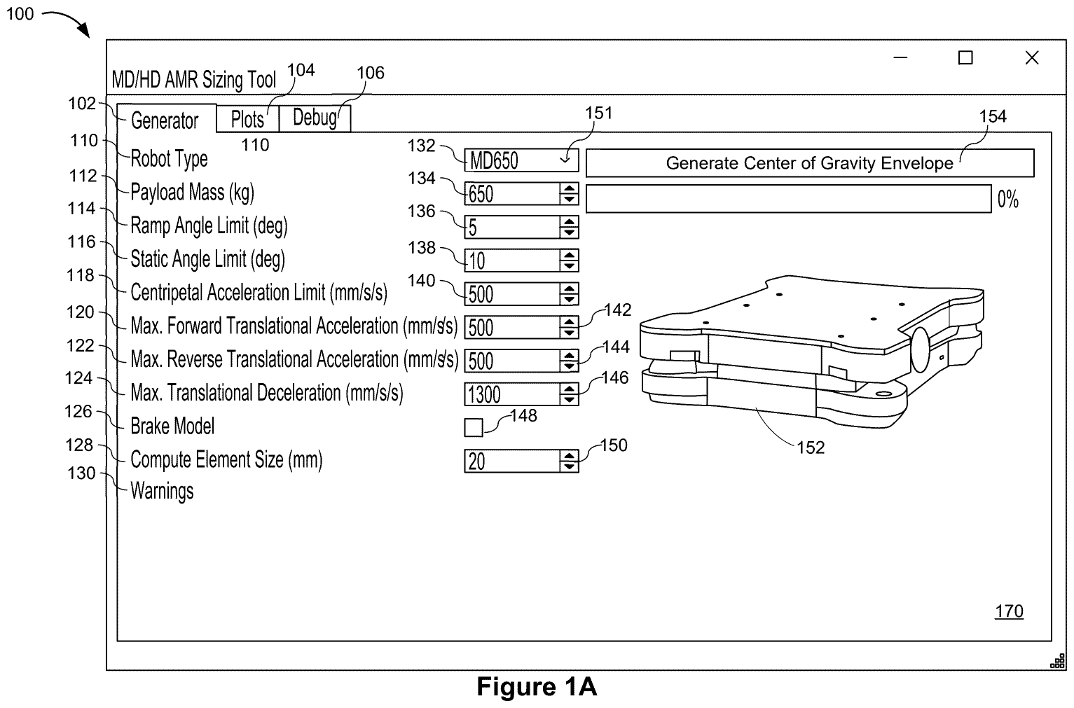

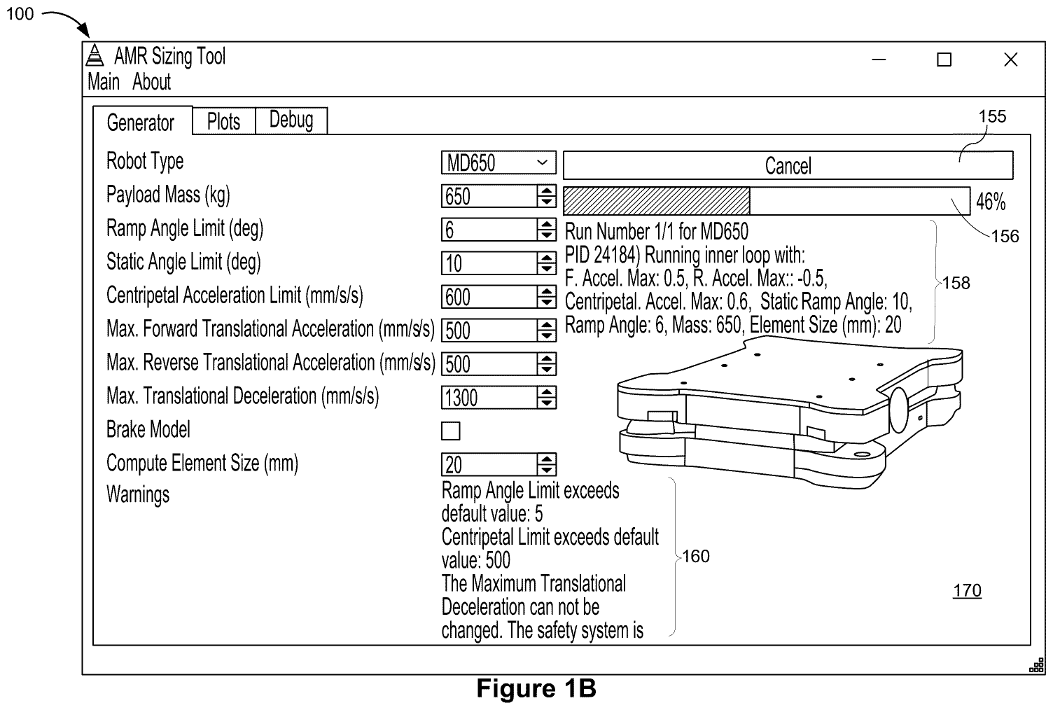

FIGS. 1A and 1B illustrate a graphical user interface 100 of an AMR sizing tool, in accordance with some embodiments.

In some embodiments, the graphical user interface 100 is a user interface of an application 422. The graphical user interface 100 includes tabs (e.g., sections or categories), such as a Generator tab 102, a Plots tab 104, and a Debug tab 106. In some embodiments, the Generator tab 102 is the default tab that is displayed when the application is launched.

In the example of FIG. 1A, the Generator tab 102 includes a generation user interface 170, which provides operating parameters and their input fields for generating a CG envelope. In accordance with some embodiments, the operating parameters include one or more of a robot type 110 (e.g., an AMR type), a payload mass 112, a ramp angle limit 114, a static angle limit 116, a centripetal acceleration limit 118, a maximum forward translational acceleration 120, a maximum reverse translational acceleration 122, a maximum translational deceleration 124, a brake model 126, and a compute element size 128. In some embodiments, the graphical user interface 100 includes a warnings region 130 (e.g., at the bottom of the graphical user interface 100) for displaying warnings.

In some embodiments, the input fields include one or more of an input field 132 for robot type, an input field 134 for payload mass, an input field 136 for ramp angle limit, an input field 138 for static angle limit, an input field 140 for centripetal acceleration limit, an input field 142 for maximum forward translational acceleration, an input field 144 for maximum reverse translational acceleration, an input field 146 for maximum translational deceleration, an input field 148 (e.g., checked or unchecked) for a brake model, and an input field 150 for compute element size. In some embodiments, the values of at least a subset of the operating parameters are set to default values in response to selection of an AMR type.

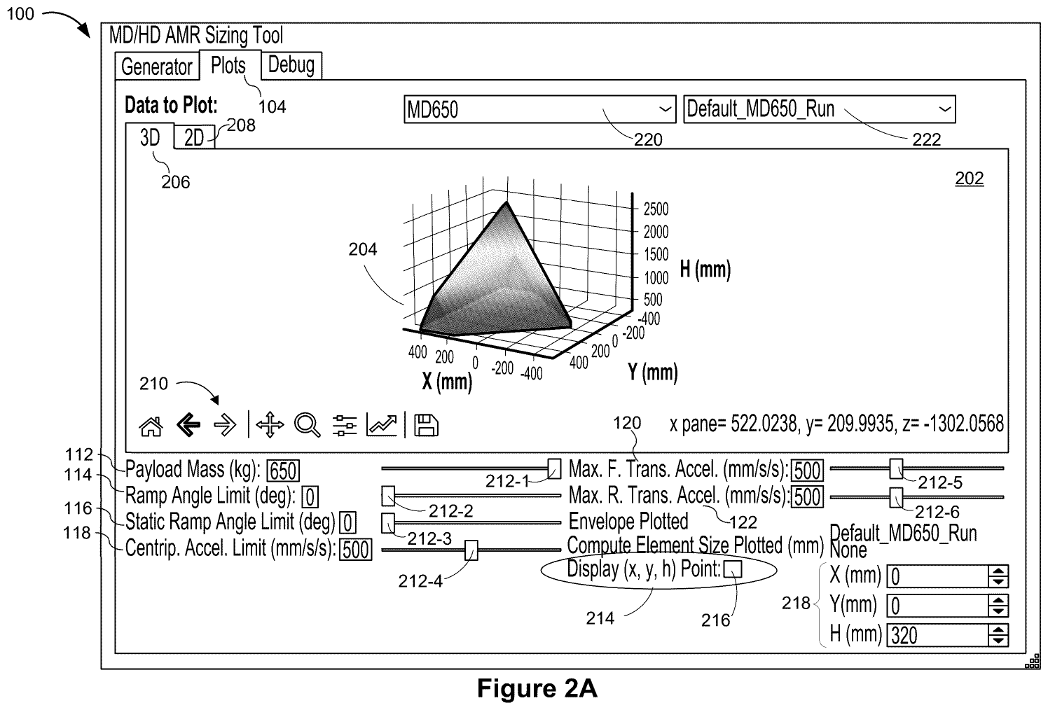

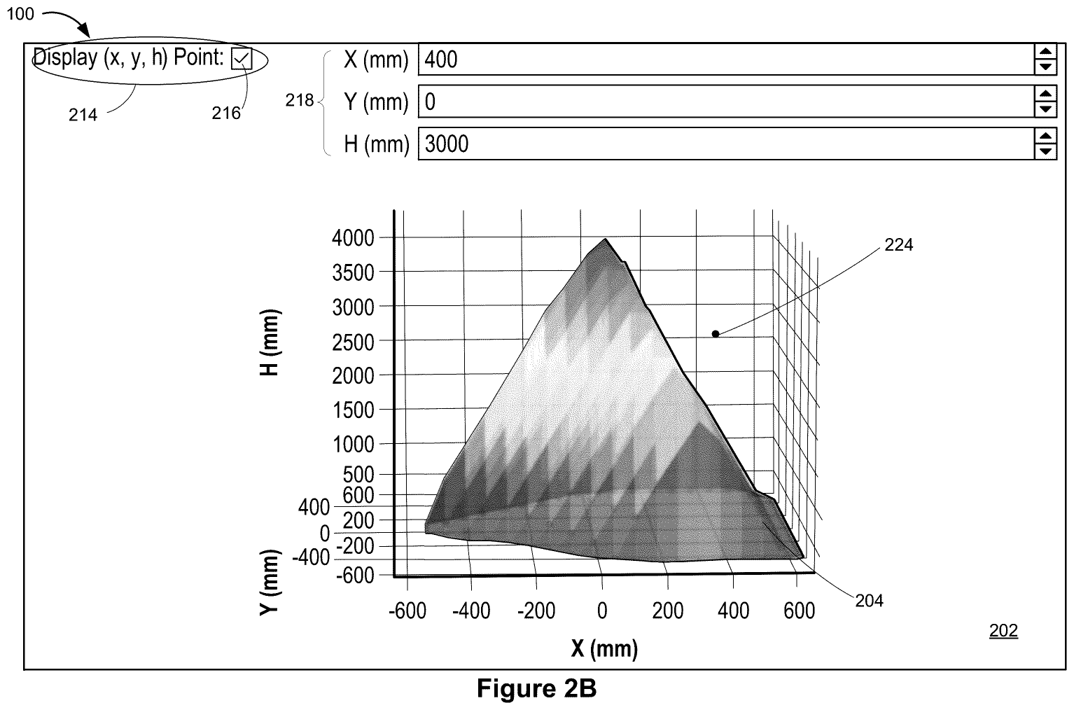

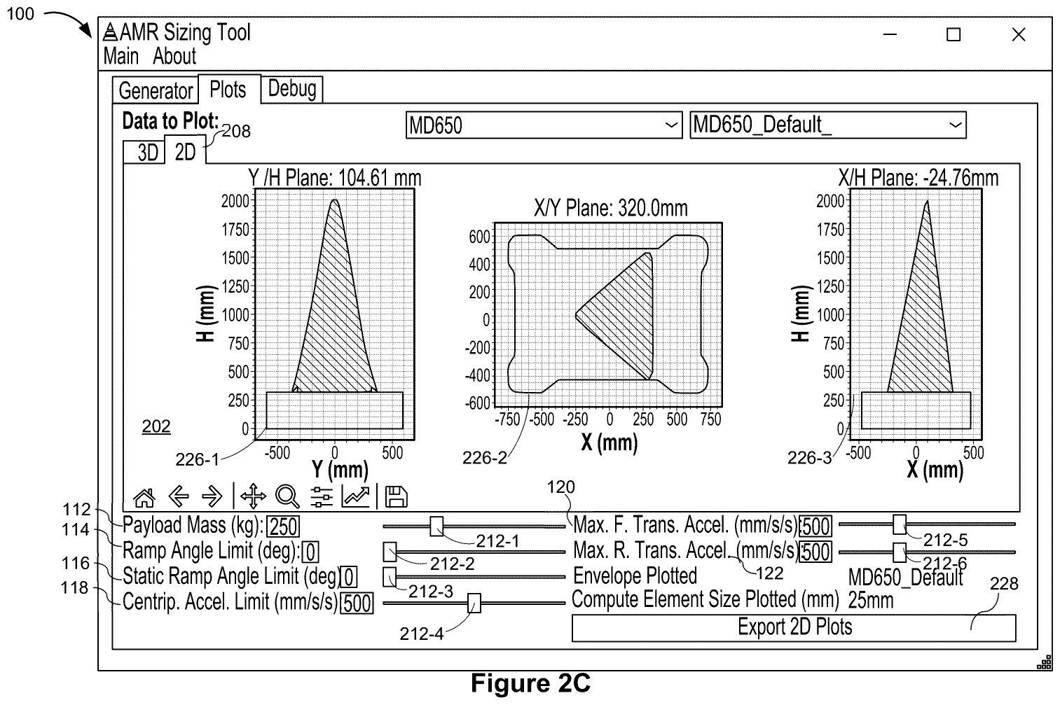

In some embodiments, in response to selection of a robot type 110 (e.g., via dropdown menu 151), the graphical user interface 100 displays an image 152 corresponding to the selected robot type (e.g., “MD650”). The graphical user interface 100 includes a “Generate Center of Gravity Envelope” affordance 154 (e.g., a user-selectable icon, an executable information item) that, when selected by a user, causes generation of information of a CG envelope (e.g., depicted in a visualization 204 in FIG. 2A) based on the AMR type and values of the operating parameters.

FIG. 1B illustrates a view of the graphical user interface 100 in response to a user selection of the affordance 154, in accordance with some embodiments. In some embodiments, in response to the user selection of the affordance 154, the application 422 determines, in real-time, a CG envelope that corresponds to the robot type and the run parameter values specified in the input fields 132, 134, 136, 138, 140, 142, 144, 146, 148, and/or 150. In some situations, while the CG envelope is being determined, the user selects the Cancel affordance 155, and determination of the CG envelope is aborted (e.g., cancelled). The graphical user interface 100 displays a progress bar 156 that depicts the progress of the process of determining the CG envelope. In some embodiments, the graphical user interface 100 displays progress text 158 that describes information of the current CG envelope being determined or a historic CG envelope that previously determined by the application 422. In some instances, the graphical user interface 100 can display, in the warnings region 130, one or more warnings 160 of exceeding default values and attempting invalid operations.

FIG. 2A illustrates the example graphical user interface 100 in accordance with some embodiments. In some embodiments, a user selection of the Plots tab 104 causes the graphical user interface 100 to display a visualization user interface 202. In some embodiments, the application 422 automatically switches from the Generator tab 102 to the Plots tab 104 when computation of a CG envelope is completed.

In FIG. 2A, the visualization user interface 202 displays a visualization 204 of a CG envelope. In this example, the visualization 204 comprises a three-dimensional (3D) plot (e.g., representation) of the CG envelope. The visualization user interface 202 includes a plot navigation toolbar region 210, which displays at least a subset of the operating parameters depicted in FIGS. 1A and 1B. In the example of FIG. 2A, the visualization user interface 202 displays operating parameters such as payload mass 112, ramp angle limit 114, static angle limit 116, centripetal acceleration limit 118, maximum forward translational acceleration 120, and maximum reverse translational acceleration 122. Each of the operating parameters includes a respective user-adjustable control (e.g., user-adjustable controls 212-1 to 212-6, a slider element) for adjusting respective values of the operating parameters. In some embodiments, a respective user-adjustable control can have a preset adjustment interval (or value) that corresponds to a set of pre-generated CG envelopes for the AMR type. In some embodiments, a respective user-adjustable control can adjust to an interval or value that is outside an adjustment interval corresponding to the set of pre-generated CG envelopes.

In some embodiments, the visualization 204 is a 3D representation of the CG envelope. The CG envelope is generated according to operating parameters whose values correspond to the positions of the user-adjustable controls 212.

In some embodiments, the visualization 204 can be updated in real time in response to changes in the values of the operating parameters (e.g., via user interaction with the user-adjustable controls 212). For example, in some embodiments, the visualization 204 is updated in real time based on a set of pre-generated CG envelopes for the AMR type. In some embodiments, the visualization of the generated CG envelope is updated automatically (e.g., without further user input) in response to adjustments to values of the operating parameters (e.g., via user interaction with the user-adjustable controls 212).

In some embodiments, the visualization user interface 202 can display one or more additional controls for adjusting rotation, zoom, colorization, and/or other display attributes for the generated CG envelope.

In some embodiments, the visualization user interface 202 includes an option 214 for displaying a point (e.g., a single point, corresponding to coordinates (x, y, z)) on the visualization 204, to allow for easier evaluation of whether it is inside or outside the CG envelope corresponding to the visualization 204. For example, in some embodiments, the visualization user interface 202 can receive a user selection of the box 216 (e.g., by checking the box) and receive user specification of coordinates for the display point via input field(s) 218. FIG. 2B illustrates that, in some embodiments, in response to receiving a user selection of the box 216 and the specification, the visualization user interface 202 updates the visualization 204 to include a point 224 having the coordinates specified in the input field(s) 218.

Referring again to FIG. 2A, in some embodiments, the visualization user interface 202 includes one or more user-selectable options, such as option 220 and option 222, that are activatable to select one or more CG envelope files for visualization. For example, a user can select an AMR type via the option 220 and select a data field via the option 222. In response to user selections of the AMR type and the data field, the application 422 generates one or more CG envelopes (e.g., stored as .pkl files) that correspond to a user-specified set of run parameters.

In some embodiments, the visualization user interface 202 includes separate tabs for 2D and 3D visualizations, such as a 3D tab 206 and a 2D tab 208. A user can toggle between these tabs to switch between the 3D visualization 204 of the CG envelope and 2D representations of the CG envelope. FIG. 2C shows that when the user selects the 2D tab 208, the visualization user interface 202 can display 2D representations (e.g., 2D plots) of the CG envelope. In FIG. 2C, the visualization user interface 202 displays a 2D representation 226-1 corresponding to a side view of the CG envelope, a 2D representation 226-2 corresponding to a top view of the CG envelope, and a 2D representation 226-3 corresponding to a front view of the CG envelope. In some embodiments, the visualization user interface 202 can include a user-selectable element 228 (e.g., an affordance item, an executable information item) that, when selected by a user, exports the 2D plots to files (e.g., having a file format such as .svg) for subsequent use by the user.

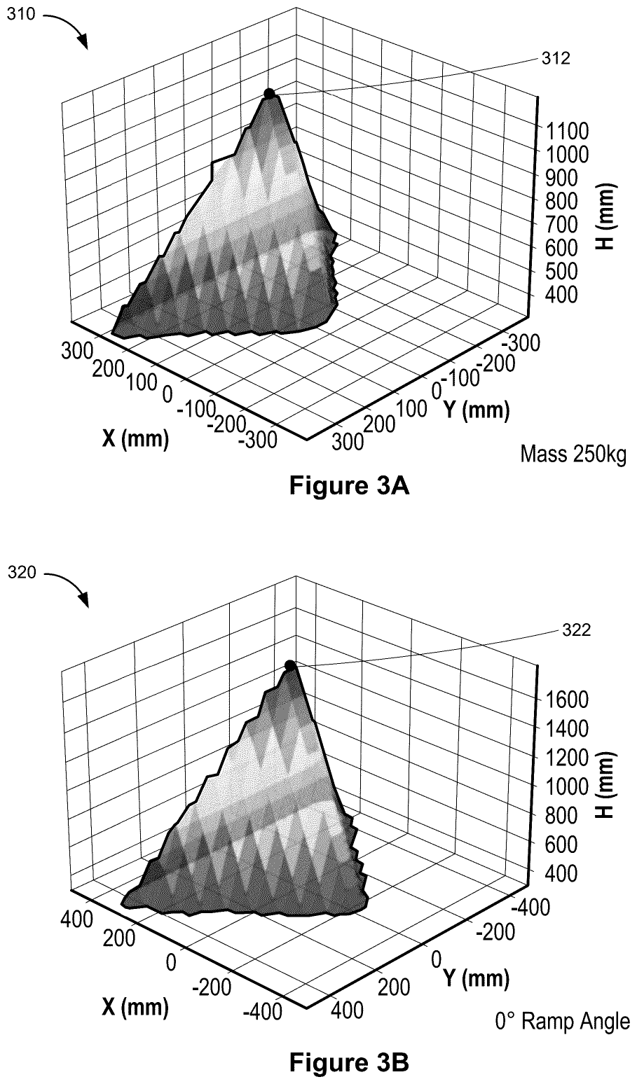

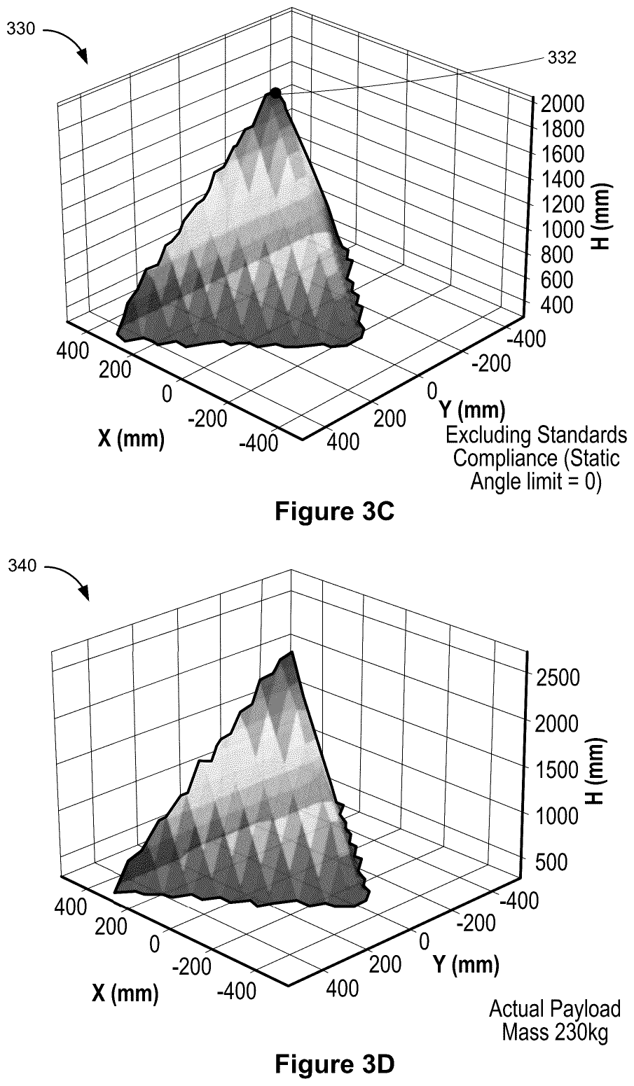

FIGS. 3A to 3D illustrate example visualization 310 to 340 of CG envelopes in four example use cases, in accordance with some embodiments. In an example, the topper has a mass of 230 kg (i.e., the payload mass is 230 kg) and the user-adjustable control 212-1 (e.g., slider element) is capable of adjusting the payload mass by 50 kg intervals. In this example, a user can adjust the control 212-1 to the nearest available payload mass, which is 250 kg. In response to the payload mass input of 250 kg, the application 422 (e.g., via the generation component 428) generates a 3D visualization 310 of a CG envelope corresponding to a payload mass of 250 kg and displays the visualization 310 in the graphical user interface 100, as illustrated in FIG. 3A. The maximum allowable topper height 312 is slightly lower than ˜1100 mm.

Referring to FIG. 3B, in another example, the operating environment of the AMR does not have ramps, and the ramp angle limit 114 can be set to zero degrees. An updated 3D visualization 320 of a CG envelope is generated by the application 422, when the ramp angle limit is set to zero degrees. The maximum allowable topper height 322 increases from ˜1100 mm (e.g., in FIG. 3A) to ˜1400 mm (in FIG. 3B).

FIG. 3C illustrates a 3D visualization 330 of a CG envelope that is generated by the application 422 when compliance with a standard (e.g., UL 3100) requirement can be safely disregarded due to known operating conditions. For example, the standard requirement may be applicable to AMRs operating in environments with static angles up to 10 degrees. However, the known operating conditions may include that the static angles in the environment are less than 5 degrees, 2 degrees, or 1 degree. In this example, the standard requirement may be disregarded (e.g., replaced with a requirement that is more applicable to the known operating conditions). In the example illustrated in FIG. 3C, the known operating condition of a static angle limit of zero allows for the maximum allowable topper height 332 to be higher than is specified in the standard, e.g., approximately 1600 mm.

In some embodiments, compliance with a standard, such as the UL 3100 standard, may be reflected in the static angle limit 116 operating parameter. For example, in some embodiments, if the static ramp angle limit has a value below 10 degrees, it no longer complies with the UL 3100 standard. UL 3100 is a standard developed by Underwriters Laboratories (UL) that focuses on safety requirements for automated mobile platforms in industrial and commercial environments. The UL 3100 standard sets forth guidelines for the evaluation and testing of a robotic system to ensure safe operation in industrial settings.

FIG. 3D illustrates a 3D visualization 340 of a CG envelope that is generated by the application 422 for a specific payload mass of 230 kg. In some embodiments, when the actual payload mass is known, a user can input the actual (e.g., precise) value (e.g., via the input field 134). The application 422 can generate a CG envelope corresponding to that payload mass and the user-selected run parameters:

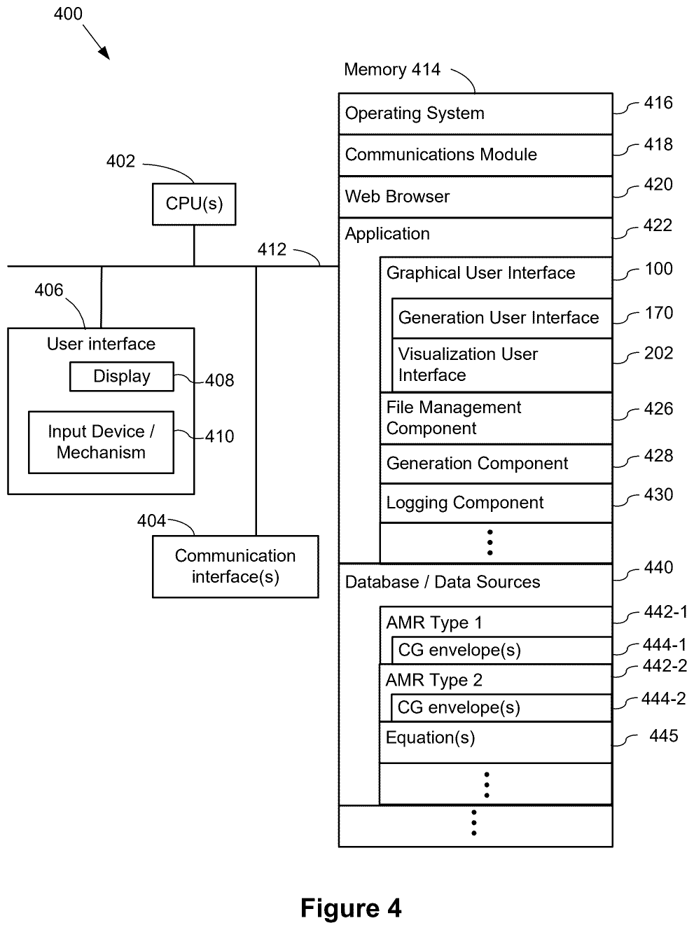

FIG. 4 is a block diagram of a computing device 400, in accordance with some implementations. Various examples of the computing device 400 include a desktop computer, a laptop computer, a tablet computer, a server computer, and other computing devices that have a processor capable of running the data visualization application 422. The computing device 400 typically includes one or more processing units/cores (CPUs) 402 for executing modules, programs, and/or instructions stored in the memory 414 and thereby performing processing operations; one or more network or other communications interfaces 404; memory 414; and one or more communication buses 412 for interconnecting these components. The communication buses 412 may include circuitry that interconnects and controls communications between system components.

The computing device 400 optionally includes a user interface 506 comprising a display device 408 and one or more input devices or mechanisms 410. In some implementations, the input device/mechanism 410 includes a keyboard. In some implementations, the input device/mechanism 410 includes a “soft” keyboard, which is displayed as needed on the display device 408, enabling a user to “press keys” that appear on the display 408. In some implementations, the display 408 and input device/mechanism 410 comprise a touch screen display (also called a touch sensitive display).

In some implementations, the memory 414 includes high-speed random-access memory, such as DRAM, SRAM, DDR RAM or other random-access solid-state memory devices. In some implementations, the memory 414 includes non-volatile memory, such as one or more magnetic disk storage devices, optical disk storage devices, flash memory devices, or other non-volatile solid state storage devices. In some implementations, the memory 414 includes one or more storage devices remotely located from the CPU(s) 402. The memory 414, or alternately the non-volatile memory device(s) within the memory 414, comprises a non-transitory computer-readable storage medium. In some implementations, the memory 414, or the computer-readable storage medium of the memory 414, stores the following programs, modules, and data structures, or a subset thereof:
an operating system 416, which includes procedures for handling various basic system services and for performing hardware dependent tasks;
a communications module 418, which is used for connecting the computing device 400 to other computers and devices via the one or more communication network interfaces 404 (wired or wireless) and one or more communication networks, such as the Internet, other wide area networks, local area networks, metropolitan area networks, and so on;
a web browser 420 (or other application capable of displaying web pages), which enables a user to communicate over a network with remote computers or devices;
an application 422, which provides tools and the graphical user interface 100 for a user to generate, visualize, and/or modify CG envelopes. In some embodiments, the application 422 is coded using a general-purpose (e.g., object-oriented) programming language (e.g., Python). In some embodiments, the application 422 includes:
   a graphical user interface 100, which is described with respect to FIGS. 1A, 1B, 2A, 2B, and 2C. In some embodiments, the graphical user interface 100 can display a generation user interface 170 that includes operating parameters (e.g., robot type 110, payload mass 112, ramp angle limit 114, static angle limit 116, centripetal acceleration limit 118, maximum forward translational acceleration 120, maximum reverse translational acceleration 122, maximum translational deceleration 124, brake model 126, and compute element size 128) and their corresponding input fields, for generating CG envelopes. In some embodiments, the graphical user interface 100 can display a visualization user interface 202 for visualizing 2D representations and 3D representations of CG envelopes;
   a file management component 426, for managing CG envelope files that are generated by a generation component 428 or pre-generated,
   the generation component 428, for generating CG envelopes (e.g., on-the-fly), in accordance with user specification of a set of user-defined run parameters. In some embodiments, the generation component 428 obtains a preset system of equations based on the AMR type. The generation component 428 computes the CG envelope by solving the preset system of equations using the corresponding set of operating parameters.
   In some embodiments, the generation component 428 applies a dynamic model to compute the CG envelope. The dynamic model is based upon the assumption that all components are rigid bodies (it does not involve finite element analysis or stress/strain simulation/solving). In some embodiments, the dynamics are given by a system of equalities, including sum of X forces, sum of Y forces, sum of Z forces, sum of moments about X, sum of moments about Y, sum of moments about Z, sum of front right rocker forces, sum of front left rocker forces, sum of rear rocker forces, and 6 additional equations corresponding to each wheel. Solving this system of equations for the given conditions/limits results in a solution vector of external forces acting on the robot. This system of equations is solved for all positions (e.g., as a grid) within the volume above the robot, resulting in each position within this gridded volume having a unique solution vector. The CG envelope is then generated by a set of inequalities that are applied to these solution vectors. In some embodiments, the inequalities represent failure conditions, such as (i) a test position fails if the normal force on any of the caster wheels is zero (caster lift-off); (ii) a test position fails if the normal force on either of the drive wheels is zero (drive wheel lift-off); (iii) a test position fails if either of the drive wheels slip; and/or (iv) a test position fails if motor current limits are exceeded; and
   a logging (e.g., debugging) component 430, for use by developers;
one or more databases/data sources 440, which are used by the application 422. In some embodiments, the databases/data sources 440 include pre-generated CG envelope(s) for various AMR types (e.g., CG envelope(s) 444-1 corresponding to AMR type 1; and G envelopes 444-2 corresponding to AMR type 2 442-2). In some embodiments, the databases/data sources 440 include equations 445 for generating CG envelopes.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 414 stores a subset of the modules and data structures identified above. Furthermore, the memory 414 may store additional modules or data structures not described above.

Although FIG. 4 shows a computing device 400, FIG. 4 is intended more as a functional description of the various features that may be present rather than as a structural schematic of the implementations described herein. In practice, and as recognized by those of ordinary skill in the art, items shown separately could be combined and some items could be separated.

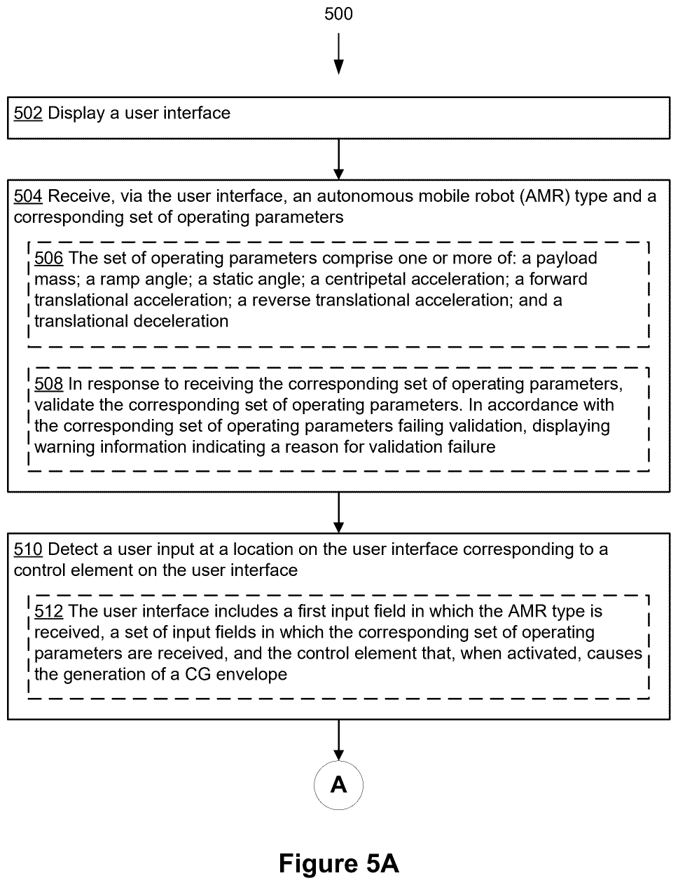

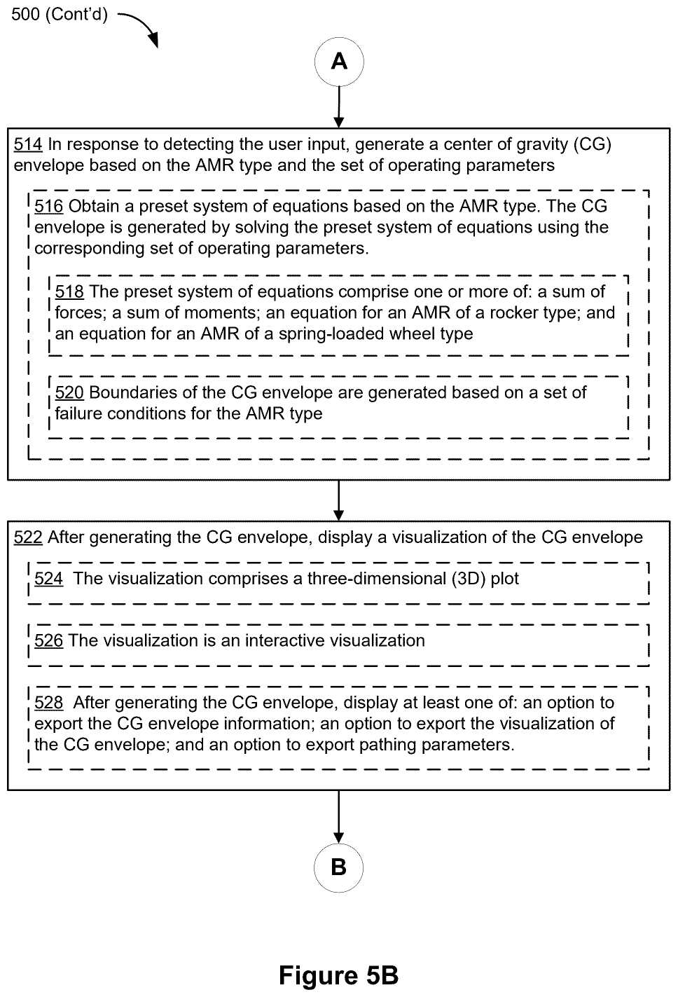

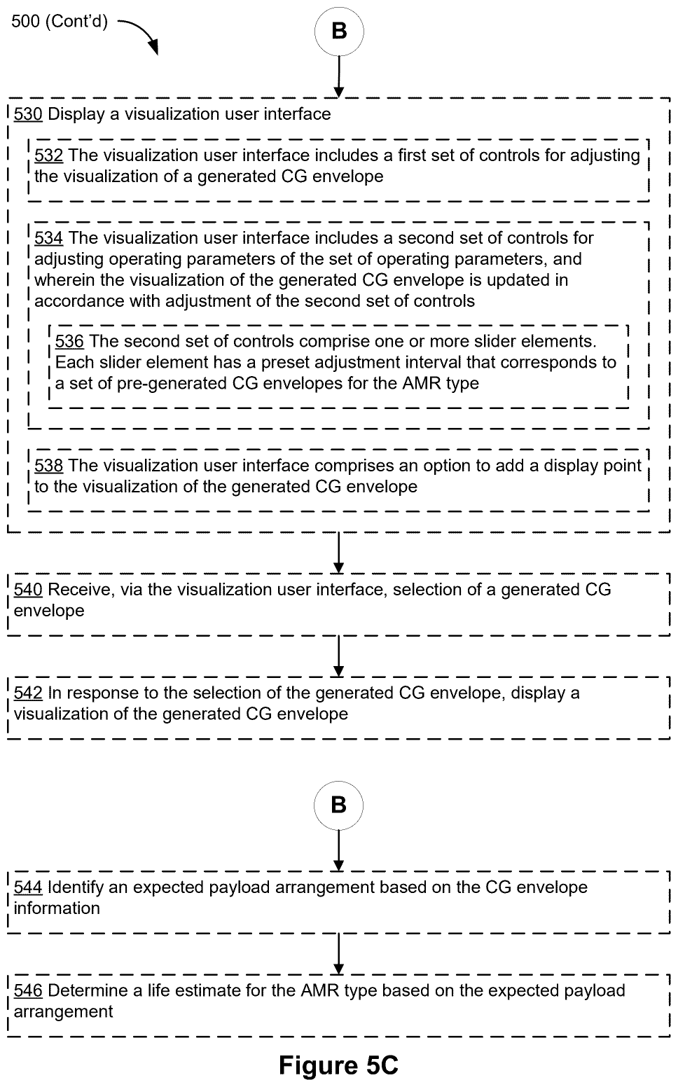

FIG. 5A-5C provide a flowchart of an example process for visualizing payload center of gravity envelopes in accordance with some embodiments. The method 500 is performed at a computing system (e.g., the computing device 400) having a display (e.g., display 408), one or more processors (e.g., CPU(s) 402), and memory (e.g., memory 414). In some embodiments, the computing system comprises a computing device and a server system. In some embodiments, the method is performed using an application (e.g., application 422, or a program, or other executable instructions). In some embodiments, the application is coded using a general-purpose (e.g., object-oriented) programming language (e.g., Python). In some embodiments, the memory stores one or more programs configured for execution by the one or more processors. In some embodiments, the operations shown in FIGS. 1A, 1B, 2A to 2C, and 3A to 3D correspond to instructions stored in the memory 414 or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 500 may be combined and/or the order of some operations may be changed. In some embodiments, some of the operations in the method 500 may be combined with other operations in the method 600.

The computing system displays (502) a user interface (e.g., graphical user interface 100).

The computing system receives (504), via the user interface, an autonomous mobile robot (AMR) type (e.g., robot type 110) and a corresponding set of operating parameters. For example, the set of operating parameters may include one or more operating parameters. In some embodiments, at least a subset of the set of operating parameters are set to default values in response to selection of an AMR type.

In some embodiments, the set of operating parameters comprise (506) one or more of: a payload mass (e.g., payload mass 112); a ramp angle (e.g., ramp angle limit 114); a static angle (e.g., static angle limit 116); a centripetal acceleration (e.g., centripetal acceleration limit 118); a forward translational acceleration (e.g., maximum forward translational acceleration 120); a reverse translational acceleration (e.g., maximum reverse translational acceleration 122); and a translational deceleration (e.g., maximum translational deceleration 124). In some embodiments, the set of operating parameters further include rocker spring forces, a dynamic friction coefficient, a static friction coefficient, an element size (e.g., voxel resolution) (e.g., compute element size 128), and dimension(s) of the AMR, such as a length, width, and/or height of the AMR.

In some embodiments, the computing system, in response to receiving the corresponding set of operating parameters, validates (508) the corresponding set of operating parameters. In accordance with the corresponding set of operating parameters failing validation, the computing system displays warning information (e.g., via warnings region 130) indicating a reason for validation failure. For example, in some embodiments, the warning information includes an indication of which operating parameters are a cause of the validation failure. In some embodiments, the warning information includes an indication of a standard (e.g., UL 3100), rule, and/or regulation that is not met due to values of the corresponding set of operating parameters. This is illustrated in FIG. 1B.

The computing system detects (510) a user input at a location on the user interface corresponding to a control element (e.g., “Generate Center of Gravity Envelope” affordance 154) on the user interface.

In some embodiments, the user interface includes (512) a first input field (e.g., input field 132) in which the AMR type is received; a set of input fields (e.g., input fields 134, 136, 138, 140, 142, 144, 146, 148, and/or 150) in which the corresponding set of operating parameters are received; and the control element (e.g., “Generate Center of Gravity Envelope” affordance 154) that, when activated, causes the generation of the CG envelope. For example, in some embodiments, the first input field comprises a dropdown menu (e.g., dropdown menu 151) with a listing of AMR types. In some embodiments, the second set of input fields comprise one or more text entry fields, one or more dropdown menu fields, and/or one or more checkboxes.

Referring to FIG. 5B, the computing system, in response to detecting the user input, generates (514) a center of gravity (CG) envelope based on the AMR type and the set of operating parameters.

In some embodiments, a payload center of mass envelope is generated based on the AMR type and the set of operating parameters in response to detecting the user input. In some embodiments, the CG envelope is further generated based on maximum and minimum driving capabilities, environmental conditions, and/or the scope of one or more compliance standards. In some embodiments, the user interface includes a visualization of the AMR type. In some embodiments, in accordance with generating the CG envelope, the user interface displays a progress indicator (e.g., a progress bar and/or progress text) (e.g., progress bar 156) for the generation. In some embodiments, in accordance with generating the CG envelope, the user interface displays a cancel option (e.g., affordance 155) to cancel the CG envelope generation.

In some embodiments, the computing system obtains (516) a preset system of equations based on the AMR type. The CG envelope is generated by solving the preset system of equations using the corresponding set of operating parameters. In some embodiments, the preset system of equations corresponds to a dynamic model for the AMR type. In some embodiments, the user interface includes a control to adjust a compute element size (e.g., compute element size 128) (e.g., a voxel resolution) for solving the preset system of equations. In some embodiments, obtaining the preset system of equations based on the AMR type includes obtaining a set of values for other parameters in the preset system of equations, the set of values corresponding to the AMR type. For example, the set of values may include a rated forward velocity, a rated backward velocity, a rated braking torque, and/or a robot mass. In some embodiments, the preset system of equations is solved for multiple positions (as a grid) within the volume above the robot.

In some embodiments, the preset system of equations comprises (518) one or more of: a sum of forces; a sum of moments; an equation for an AMR of a rocker type; and an equation for an AMR of a spring-loaded wheel type. For example, the system of equations may include sums of forces along X, Y, and Z directions/axes, sums of moments about X, Y, and Z directions/axes, balancing forces for each rocker on the AMR, and/or equations for each wheel on the AMR. In some embodiments, the sums of forces correspond to the entire AMR system. In some embodiments, the sums of forces correspond to a subsystem (e.g., the rocker subsystem). In some embodiments, the sums of moments correspond to the entire AMR system. In some embodiments, the sums of moments correspond to a subsystem (e.g., the rocker subsystem).

In some embodiments, boundaries of the CG envelope are generated (520) based on a set of failure conditions for the AMR type. In some embodiments, the set of failure conditions include one or more of a normal force on a wheel is zero (e.g., represented the wheel lifting off the ground), a wheel slip condition occurs, or a motor current limit is exceeded.

The computing system, after generating the CG envelope, displays (522) a visualization of the CG envelope.

In some embodiments, the visualization comprises (524) a three-dimensional (3D) plot, such as 3D visualization 204. For example, the visualization includes a 3D representation of the CG envelope. In some embodiments, the visualization comprises a two-dimensional (2D) plot (e.g., corresponding to a side, top, front, or back view) (e.g., 2D representations 226-1, 226-2, and/or 226-3).

In some embodiments, the visualization is (526) an interactive visualization. For example, the visualization may be updated by adjusting one or more sliders (e.g., user-adjustable controls 212) displayed with the visualization, the sliders corresponding to the set of operating parameters.

In some embodiments, the computing device, after generating the CG envelope, displays (528) at least one of: an option to export the CG envelope information; an option to export the visualization of the CG envelope (e.g., via user-selectable element 228); and an option to export pathing parameters. In some embodiments, each option is represented with a respective executable information item on a user interface. In some embodiments, the pathing parameters correspond to limits/restrictions on AMR pathing based on the expected payload. For example, using straight pathing to reduce centripetal acceleration.

With continued reference to FIG. 5C, in some embodiments, the computing system displays (530) a visualization user interface (e.g., visualization user interface 202).

In some embodiments, the visualization user interface includes (532) a first set of controls for adjusting the visualization of the generated CG envelope. For example, the first set of controls comprise controls for adjusting rotation, zoom, colorization, and/or other display attributes for the generated CG envelope. In some embodiments, the visualization user interface further includes an option to export visualizations of generated CG envelopes.

In some embodiments, the visualization user interface includes (534) a second set of controls for adjusting operating parameters of the set of operating parameters. For example, this is illustrated in FIGS. 2A and 2C. The visualization of the generated CG envelope is updated in accordance with adjustment of the second set of controls. In some embodiments, the visualization of the generated CG envelope is updated in real time in response to adjustments to the second set of controls (e.g., using a set of pre-generated CG envelopes for the AMR type). In some embodiments, the visualization of the generated CG envelope is updated automatically (e.g., without further user input) in response to adjustments to the second set of controls.

In some embodiments, the second set of controls comprise (536) one or more slider elements. Each slider element has a preset adjustment interval that corresponds to a set of pre-generated CG envelopes for the AMR type. In some embodiments, the one or more slider elements include a slider element that can adjust to an interval or value that is outside the preset adjustment interval.

In some embodiments, the visualization user interface comprises (538) an option to add a display point to the visualization of the generated CG envelope (e.g., via option 214). For example, the visualization user interface includes input field(s) (e.g., input fields 218) to receive coordinates for the display point.

In some embodiments, the computing system receives (540), via the visualization user interface, selection of a generated CG envelope.

In some embodiments, the computing system, in response to the selection of the generated CG envelope, displays (542) a visualization of the generated CG envelope. In some embodiments, the visualization user interface includes a two-dimensional (2D) visualization of the CG envelope and/or a 3D visualization of the CG envelope. For example, the visualization user interface includes separate portions, windows, or tabs for the 2D and 3D visualizations (e.g., tab 206 and tab 208). In some embodiments, the visualization user interface includes a control that is activatable to select one or more CG envelope files for visualization.

In some embodiments, the computing system identifies (544) an expected payload arrangement based on the CG envelope information, and determines (546) a life estimate for the AMR type based on the expected payload arrangement. In some embodiments, the method further includes displaying the life estimate and/or displaying information regarding adjusting the payload arrangement to extend the life estimate. For example, the life estimate is determined based on estimated wear due to the payload arrangement and operating conditions.

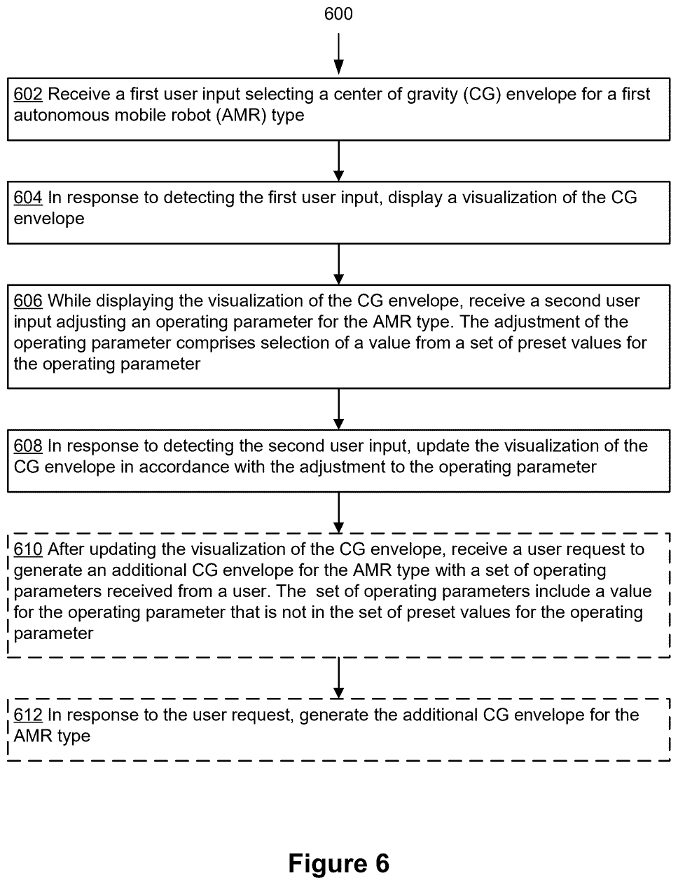

FIG. 6 provides a flowchart of an example process for verifying a payload in accordance with some embodiments. The method 600 is performed at a computing system (e.g., the computing device 400) having a display (e.g., display 408), one or more processors (e.g., CPU(s) 402), and memory (e.g., memory 414). Some operations in the method 500 may be combined and/or the order of some operations may be changed. In some embodiments, the computing system comprises a computing device and a server system. Some operations in the method 600 may be combined and/or the order of some operations may be changed. In some embodiments, some of the operations in the method 600 may be combined with other operations in the method 500.

The computing system receives (602) a first user input selecting a center of gravity (CG) envelope for a first autonomous mobile robot (AMR) type.

The computing system, in response to detecting the first user input, displays (604) a visualization of the CG envelope. For example, the visualization may be any of the 2D or 3D visualizations described herein.

The computing system, while displaying the visualization of the CG envelope, receives (606) a second user input adjusting an operating parameter for the AMR type. For example, the operating parameter may be any of the operating parameters described herein. The adjustment of the operating parameter comprises selection of a value from a set of preset values for the operating parameter. In some embodiments, the adjustment to the operating parameter is in accordance with a preset step size for the operating parameter.

The computing system, in response to detecting the second user input, updates (608) the visualization of the CG envelope in accordance with the adjustment to the operating parameter.

In some embodiments, the computing system, after updating the visualization of the CG envelope, receives (610) a user request to generate an additional CG envelope for the AMR type with a set of operating parameters received from a user. The set of operating parameters include a value for the operating parameter that is not in the set of preset values for the operating parameter; and

In some embodiments, the computing system, in response to the user request, generates the additional CG envelope for the AMR type. In some embodiments, the additional CG envelope is displayed for the user (e.g., automatically upon generation). In some embodiments, the additional CG envelope is selectable after generation (e.g., in a similar manner as the CG envelope was selected by the first user input).

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Turning now to some example embodiments.

(A1) In one aspect, some embodiments include a method of visualizing payload center of gravity envelopes. The method is performed at a computing system (e.g., the computing device 400) having memory and one or more processors. The method includes (i) displaying a user interface; (ii) receiving, via the user interface, an autonomous mobile robot (AMR) type and a corresponding set of operating parameters; (iii) detecting a user input at a location on the user interface corresponding to a control element on the user interface; (iv) in response to detecting the user input, generating a center of gravity (CG) envelope based on the AMR type and the set of operating parameters; and (v) after generating the CG envelope, displaying a visualization of the CG envelope.

For example, the set of operating parameters may include one or more operating parameters. In some embodiments, at least a subset of the set of operating parameters are set to default values in response to selection of an AMR type. In some embodiments, a payload center of mass envelope is generated based on the AMR type and the set of operating parameters in response to detecting the user input. In some embodiments, the CG envelope is further generated based on maximum and minimum driving capabilities, environmental conditions, and/or the scope of one or more compliance standards. In some embodiments, the user interface includes a visualization of the AMR type. In some embodiments, in accordance with generating the CG envelope, the user interface displays a progress indicator (e.g., a progress bar and/or progress text) for the generation. In some embodiments, in accordance with generating the CG envelope, the user interface displays a cancel option to cancel the CG envelope generation.

In some embodiments, the method is performed using an application (or a program, or other executable). In some embodiments, the application is coded using a general-purpose (e.g., object-oriented) programming language (e.g., Python). In some embodiments, the application includes the user interface, a file management component (e.g., for CG envelope files), a generation component (e.g., for generating the CG envelopes), and/or a logging (debugging) component.

(A2) In some embodiments of A1, the visualization comprises a three-dimensional (3D) plot. For example, the visualization includes a 3D representation of the CG envelope. In some embodiments, the visualization comprises a two-dimensional (2D) plot (e.g., corresponding to a side, top, front, or back view).

(A3) In some embodiments of A1 or A2, the visualization is an interactive visualization. For example, the visualization may be updated by adjusting one or more sliders displayed with the visualization, the sliders corresponding to the set of operating parameters.

(A4) In some embodiments of any of A1-A3, the user interface includes (i) a first input field in which the AMR type is received; (ii) a set of input fields in which the corresponding set of operating parameters are received; and (iii) the control element that, when activated, causes the generation of the CG envelope. In some embodiments, the first input field comprises a dropdown menu with a listing of AMR types. In some embodiments, the second set of input fields comprise one or more text entry fields, one or more dropdown menu fields, and/or one or more checkboxes.

(A5) In some embodiments of any of A1-A4, the method includes (i) displaying a visualization user interface; (ii) receiving, via the visualization user interface, selection of a generated CG envelope; and (iii) in response to the selection of the generated CG envelope, displaying a visualization of the generated CG envelope. In some embodiments, the visualization user interface includes a two-dimensional (2D) visualization of the CG envelope and/or a 3D visualization of the CG envelope. For example, the visualization user interface includes separate portions, windows, or tabs for the 2D and 3D visualizations. In some embodiments, the visualization user interface includes a control that is activatable to select one or more CG envelope files for visualization.

(A6) In some embodiments of A5, the visualization user interface includes a first set of controls for adjusting the visualization of the generated CG envelope. For example, the first set of controls comprise controls for adjusting rotation, zoom, colorization, and/or other display attributes for the generated CG envelope. In some embodiments, the visualization user interface further includes an option to export visualizations of generated CG envelopes.

(A7) In some embodiments of A5 or A6, the visualization user interface includes a second set of controls for adjusting operating parameters of the set of operating parameters. The visualization of the generated CG envelope is updated in accordance with adjustment of the second set of controls. In some embodiments, the visualization of the generated CG envelope is updated in real time in response to adjustments to the second set of controls (e.g., using a set of pre-generated CG envelopes for the AMR type). In some embodiments, the visualization of the generated CG envelope is updated automatically (e.g., without further user input) in response to adjustments to the second set of controls.

(A8) In some embodiments of A7, the second set of controls comprise one or more slider elements, each slider element having a preset adjustment interval that corresponds to a set of pre-generated CG envelopes for the AMR type. In some embodiments, the one or more slider elements include a slider element that can adjust to an interval or value that is outside the preset adjustment interval.

(A9) In some embodiments of any of A5-A8, the visualization user interface comprises an option to add a display point to the visualization of the generated CG envelope. For example, the visualization user interface includes input field(s) to receive coordinates for the display point.

(A10) In some embodiments of any of A1-A9, the set of operating parameters comprise one or more of: a payload mass; a ramp angle; a static angle; a centripetal acceleration; a forward translational acceleration; a reverse translational acceleration; a translational deceleration; and a geometry of the AMR. In some embodiments, the set of operating parameters further include rocker spring forces, a dynamic friction coefficient, a static friction coefficient, an element size (e.g., voxel resolution), and dimension(s) of the AMR.

(A11) In some embodiments of any of A1-A10, the method further comprising obtaining a preset system of equations based on the AMR type. The CG envelope is generated by solving the preset system of equations using the corresponding set of operating parameters.

In some embodiments, the preset system of equations corresponds to a dynamic model for the AMR type. In some embodiments, the user interface includes a control to adjust a compute element size (e.g., a voxel resolution) for solving the preset system of equations. In some embodiments, obtaining the preset system of equations based on the AMR type includes obtaining a set of values for other parameters in the preset system of equations, the set of values corresponding to the AMR type. For example, the set of values may include a rated forward velocity, a rated backward velocity, a rated braking torque, and/or a robot mass. In some embodiments, the preset system of equations is solved for multiple positions (as a grid) within the volume above the robot.

(A12) In some embodiments of A11, the preset system of equations comprises one or more of: a sum of forces; a sum of moments; an equation for a rocker of the AMR type; and an equation for a wheel of the AMR type. For example, the system of equations may include sums of forces along X, Y, and Z, sums of moments about X, Y, and Z, balancing forces for each rocker on the AMR, and/or equations for each wheel on the AMR. In some embodiments, the sums of forces correspond to the entire AMR system. In some embodiments, the sums of forces correspond to a subsystem (e.g., the rocker subsystem). In some embodiments, the sums of moments correspond to the entire AMR system. In some embodiments, the sums of moments correspond to a subsystem (e.g., the rocker subsystem).

(A13) In some embodiments of A11 or A12, boundaries of the CG envelope are generated based on a set of failure conditions for the AMR type. In some embodiments, the set of failure conditions include one or more of a normal force on a wheel is zero (e.g., represented the wheel lifting off the ground), a wheel slip condition occurs, a motor current limit is exceeded.

(A14) In some embodiments of any of A1-A13, the method includes (i) in response to receiving the corresponding set of operating parameters, validating the corresponding set of operating parameters; and (ii) in accordance with the corresponding set of operating parameters failing validation, displaying warning information indicating a reason for validation failure. In some embodiments, the warning information includes an indication of which operating parameters are a cause of the validation failure. In some embodiments, the warning information includes an indication of a standard (e.g., UL 3100), rule, and/or regulation that is not met due to values of the corresponding set of operating parameters.

(A15) In some embodiments of any of A1-A14, the method includes after generating the CG envelope, displaying at least one of: (i) an option to export the CG envelope information; (ii) an option to export the visualization of the CG envelope; and (iii) an option to export pathing parameters. In some embodiments, the pathing parameters correspond to limits/restrictions on AMR pathing based on the expected payload. For example, using straight pathing to reduce centripetal acceleration.

(A16) In some embodiments of any of A1-A15, the method includes (i) identifying an expected payload arrangement based on the CG envelope information; and (ii) determining a life estimate for the AMR type based on the expected payload arrangement. In some embodiments, the method further includes displaying the life estimate and/or displaying information regarding adjusting the payload arrangement to extend the life estimate.

(B1) In one aspect, some embodiments include a method of verifying a payload. The method includes: (i) receiving a first user input selecting a center of gravity (CG) envelope for a first autonomous mobile robot (AMR) type; (ii) in response to detecting the first user input, displaying a visualization of the CG envelope; (iii) while displaying the visualization of the CG envelope, receiving a second user input adjusting an operating parameter for the AMR type, where the adjustment of the operating parameter comprises selection of a value from a set of preset values for the operating parameter; and (iv) in response to detecting the second user input, updating the visualization of the CG envelope in accordance with the adjustment to the operating parameter. For example, the visualization may be any of the 2D or 3D visualizations described herein, and the operating parameter may be any of the operating parameters described herein. In some embodiments, the adjustment to the operating parameter is in accordance with a preset step size for the operating parameter.

(B2) In some embodiments of B1, the method includes (i) after updating the visualization of the CG envelope, receiving a user request to generate an additional CG envelope for the AMR type with a set of operating parameters received from a user, where the set of operating parameters include a value for the operating parameter that is not in the set of preset values for the operating parameter; and (ii) in response to the user request, generating the additional CG envelope for the AMR type. In some embodiments, the additional CG envelope is displayed for the user (e.g., automatically upon generation). In some embodiments, the additional CG envelope is selectable after generation (e.g., in a similar manner as the CG envelope was selected by the first user input).

(C1) In one aspect, some embodiments include a system comprising one or more processors and memory that is in communication with the one or more processors. The memory stores instructions for performing the method of A1-A16 or B1-B2.

(D1) In one aspect, some embodiments include a non-transitory computer-readable storage medium including instructions that, when executed by a computing system, cause the computing system to perform the method of any of A1-A16 or B1-B2.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining”can include resolving, selecting, choosing, establishing and the like.

The phrase “based on” does not mean “based only on,” unless expressly specified otherwise. In other words, the phrase “based on” describes both “based only on” and “based at least on.”

As used herein, the term “exemplary” means “serving as an example, instance, or illustration,” and does not necessarily indicate any preference or superiority of the example over any other configurations or embodiments.

As used herein, the term “and/or” encompasses any combination of listed elements. For example, “A, B, and/or C” entails each of the following possibilities: A only, B only, C only, A and B without C, A and C without B, B and C without A, and a combination of A, B, and C.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A method of visualizing payload center of gravity envelopes, the method comprising:
displaying a user interface;
receiving, via the user interface, an autonomous mobile robot (AMR) type and a corresponding set of operating parameters;
detecting a user input at a location on the user interface corresponding to a control element on the user interface;
in response to detecting the user input, generating a center of gravity (CG) envelope based on the AMR type and the set of operating parameters; and
after generating the CG envelope, displaying a visualization of the CG envelope.

2. The method of claim 1, wherein the visualization comprises a three-dimensional (3D) plot.

3. The method of claim 1, wherein the visualization includes an interactive visualization.

4. The method of claim 1, wherein the user interface includes:
a first input field in which the AMR type is received;
a set of input fields in which the corresponding set of operating parameters are received; and
the control element that, when activated, causes the generation of the CG envelope.

5. The method of claim 1, further comprising:
displaying a visualization user interface;
receiving, via the visualization user interface, selection of a generated CG envelope; and
in response to the selection of the generated CG envelope, displaying a visualization of the generated CG envelope.

6. The method of claim 5, wherein the visualization user interface includes a first set of controls for adjusting the visualization of the generated CG envelope.

7. The method of claim 5, wherein the visualization user interface includes a second set of controls for adjusting operating parameters of the set of operating parameters, and wherein the visualization of the generated CG envelope is updated in accordance with adjustment of the second set of controls.

8. The method of claim 7, wherein the second set of controls comprise one or more slider elements, each slider element having a preset adjustment interval that corresponds to a set of pre-generated CG envelopes for the AMR type.

9. The method of any of claim 5, wherein the visualization user interface comprises an option to add a display point to the visualization of the generated CG envelope.

10. The method of any claim 1, wherein the set of operating parameters comprise one or more of:
a payload mass;
a ramp angle;
a static angle;
a centripetal acceleration;
a forward translational acceleration;
a reverse translational acceleration;
a translational deceleration; and
a geometry of the AMR.

11. The method of claim 1, further comprising obtaining a preset system of equations based on the AMR type, wherein the CG envelope is generated by solving the preset system of equations using the corresponding set of operating parameters.

12. The method of claim 11, wherein the preset system of equations comprise one or more of:
a sum of forces;
a sum of moments;
an equation for a rocker of the AMR type; and
an equation for a wheel of the AMR type.

13. The method of claim 11, wherein boundaries of the CG envelope are generated based on a set of failure conditions for the AMR type.

14. The method of claim 1, further comprising:
in response to receiving the corresponding set of operating parameters, validating the corresponding set of operating parameters; and
in accordance with the corresponding set of operating parameters failing validation, displaying warning information indicating a reason for validation failure.

15. The method of claim 1, further comprising, after generating the CG envelope, displaying at least one of:
an option to export information of the CG envelope;
an option to export the visualization of the CG envelope; and
an option to export pathing parameters.

16. The method of claim 1, further comprising:
identifying an expected payload arrangement based on the CG envelope; and
determining a life estimate for the AMR type based on the expected payload arrangement.

17. The method of claim 1, further comprising:
while displaying the visualization of the CG envelope, receiving a second user input adjusting an operating parameter for the AMR type, wherein the adjustment of the operating parameter comprises selection of a value from a set of preset values for the operating parameter; and
in response to detecting the second user input, updating the visualization of the CG envelope in accordance with the adjustment to the operating parameter.

18. The method of claim 17, the method further comprises:
after updating the visualization of the CG envelope, receiving a user request to generate an additional CG envelope for the AMR type with a second set of operating parameters received from a user, wherein the second set of operating parameters include a value for the operating parameter that is not in the set of preset values for the operating parameter; and
in response to the user request, generating the additional CG envelope for the AMR type.

19. A system, comprising:
one or more processors;
memory that is in communication with the one or more processors; and
one or more programs stored in the memory and configured for execution by the one or more processors, the one or more programs comprising instructions for:
displaying a user interface;
receiving, via the user interface, an autonomous mobile robot (AMR) type and a corresponding set of operating parameters;
detecting a user input at a location on the user interface corresponding to a control element on the user interface;
in response to detecting the user input, generating a center of gravity (CG) envelope based on the AMR type and the set of operating parameters; and
after generating the CG envelope, displaying a visualization of the CG envelope.

20. A non-transitory computer-readable storage medium storing one or more programs configured for execution by a computing system having one or more processors and memory, the one or more programs comprising instructions for:
displaying a user interface;
receiving, via the user interface, an autonomous mobile robot (AMR) type and a corresponding set of operating parameters;
detecting a user input at a location on the user interface corresponding to a control element on the user interface;
in response to detecting the user input, generating a center of gravity (CG) envelope based on the AMR type and the set of operating parameters; and
after generating the CG envelope, displaying a visualization of the CG envelope.
